(19) United States
(12) Patent Application Publication
(10) Pub. No.: US 2011/0043679 A1
(43) Pub. Date: Feb. 24, 2011

(54) CAMERA DEVICE AND ADJUSTING METHOD FOR THE SAME

(75) Inventors: HOU-HSIEN LEE, Tu-Cheng (TW); CHANG-JUNG LEE, Tu-Cheng (TW); CHIH-PING LO, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/606,199

(22) Filed: Oct. 27, 2009

(30) Foreign Application Priority Data
Aug. 21, 2009 (CN) 200910305888.9

(51) Int. Cl. H04N 5/232

(52) U.S. Cl. 348/348; 348/E05.045

(57) ABSTRACT

A camera device includes a light detection and ranging system to emit laser light to scan a determined scene to obtain three-dimensional information of the determined scene. The camera device stores a first set of three-dimensional information of the determined scene at a first time, and compares a second set of three-dimensional information of the determined scene at a second time with the first set of three-dimensional information, to determine whether there is an invading object in the determined or not, and then sends a driving command to a driving module to adjust a lens angle and a focus of an image capture module to capture images of the invading object in focus in response to there being a invading object.

### BACKGROUND

1. Technical Field

The present disclosure relates to a camera device and an adjusting method for the camera device.

2. Description of Related Art

A light detection and ranging (LIDAR) system is an optical sensing system usually used to collect topographic data. For example, the system is widely used by the national oceanic and atmospheric administration (NOAA) and national aeronautics and space administration (NASA) scientists to document topographic changes along shorelines. In general, a LIDAR system is capable of emitting laser lights at a rate of 7,000 to 8,000 pulses per second, to have a scanning measurement with a high precision. The LIDAR system depends on the known speed of light, proximately 0.3 meters per nanosecond. Using this constant, a returning light photon has traveled to and from an object can be calculated.

A conventional camera device for surveilance does not includes usualla LIDAR system to scan a determined scene, thereby cannot accurately identified and locate an unexpected visitors/invaders.

### BRIEF DESCRIPTION OF THE DRAWINGS

FIG. 1 is a block diagram of an exemplary embodiment of a camera device.

FIG. 2A and FIG. 2B are sketch views of using the camera device of FIG. 1 to capture an image of an invading object.

FIG. 3 is flowchart of an exemplary embodiment of an adjusting method for the camera device of FIG. 1.

### DETAILED DESCRIPTION

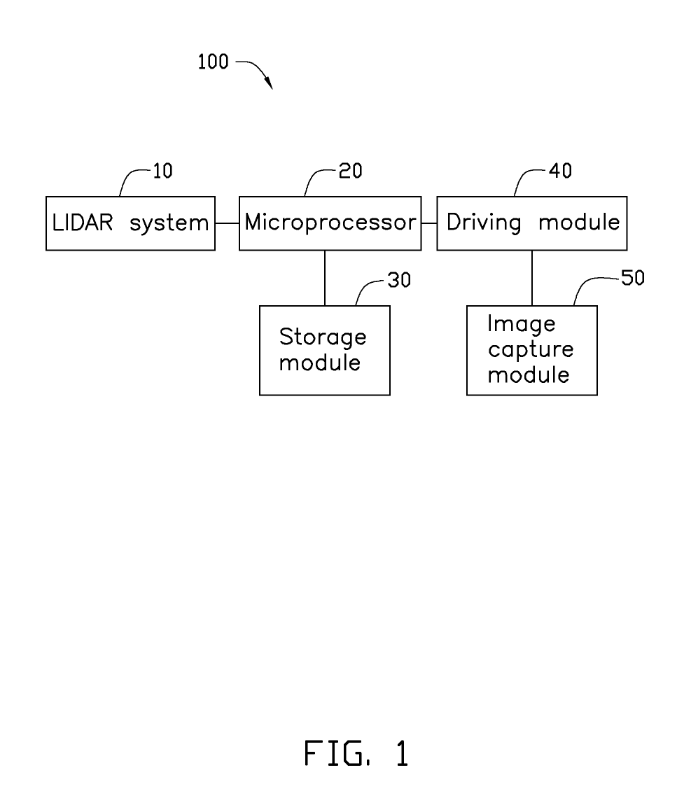

Referring to FIG. 1, an exemplary embodiment of a camera device 100 is used to monitor a determined scene. The camera device 100 includes a light detection and ranging (LIDAR) system, a microprocessor 20, a storage module 30, a driving module 40, and an image capture module 50.

The image capture module 50 may include a charge coupled device (CCD) (not shown) and a lens (not shown). The driving module 40 includes a motor (not shown) and a driver (not shown). The driver is used to drive the motor to adjust the lens of the image capture module 50, thereby to modify a lens angle and a focus of the image capture module 50.

The LIDAR system 10 is capable of continuously emitting laser light to scan the determined scene, thereby to obtain three-dimensional information of the determined scene. In one exemplary embodiment, the three-dimensional information of the determined scene includes three-dimensional coordinates of objects in the determined scene. The process that the three-dimensional coordinates of the objects in the determined scene are obtained will be explained in further detail below.

For example, when the LIDAR system 10 transmits a beam of laser light towards the determined scene, the light reflects from an object in the determined scene to the LIDAR system 10. Therefore, a distance of the object away from the LIDAR system 10 can be obtained according to a speed of the light multiplied by half a time delay between a transmission pulse and a reflected pulse of the light. Therefore, three-dimensional coordinates of the objects in the determined scene are obtained by the LIDAR system 10.

Therefore, when the LIDAR system 10 transmits two beams of light one after the other during a period, two sets of three-dimensional information of the determined scene will be obtained. If the two sets of the three-dimensional information of the determined scene are not equal to each other or a difference between the two sets of the three-dimensional information exceeds a pre-determined value, an invading object will be detected. How the invading object is detected will be explained in further detail below.

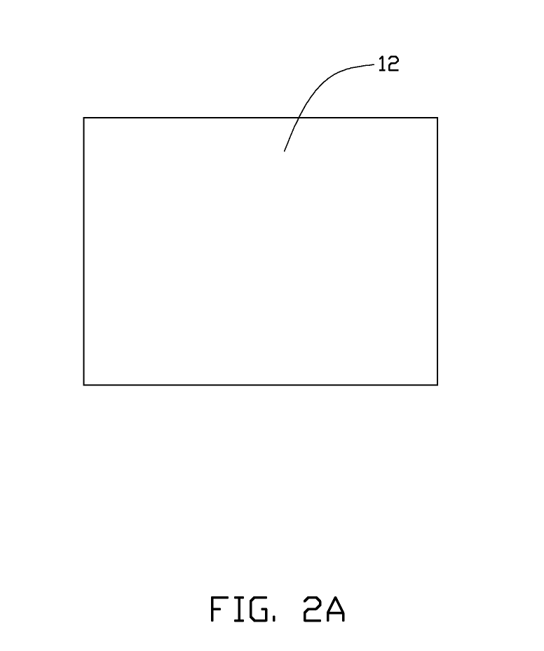

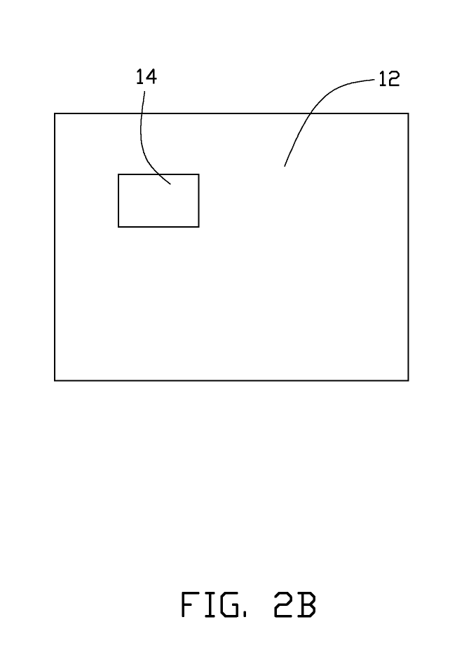

Referring to FIG. 2A and FIG. 2B, in use, the LIDAR system 10 transmits a first beam of laser light to scan a determined scene 12 at a first time, to obtain a first set of three-dimensional information of the determined scene 12, shown in FIG. 2A, which includes three-dimensional coordinates of all objects in the determined scene 12 at the first time. The first three-dimensional information of the determined scene 12 is then transmitted to the microprocessor 20 and stored in the storage module 30, functioning as a piece of standard information.

The LIDAR system 10 continues to transmit a second beam of laser light to scan the determined scene 12 at a second time, to obtain a second set of three-dimensional information of the determined scene 12, shown in FIG. 2B, which includes three-dimensional coordinates of all objects in the determined scene at the second time. The second set of three-dimensional information of the determined scene 12 is then transmitted to the microprocessor 20. The microprocessor 20 compares the second set of three-dimensional information of the determined scene 12 with the first set of three-dimensional information of the determined scene 12 stored in the storage module 30.

When the second set of three-dimensional information and the first set of three-dimensional information of the determined scene are equal to each other, or a difference between the first and second sets of three-dimensional information does not exceed a pre-determined value, which means there is no invading object in the determined scene, the LIDAR system 10 continues to transmit a next beam of laser light to scan the determined scene 12.

When the first and second sets of three-dimensional information of the determined scene 12 are not equal to each other, or a difference between the first and second sets of three-dimensional information exceeds the pre-determined value, an invading object, e.g., a moving object 14, is detected. The moving object 14 is determined at a position of the determined scene with the first and second sets of three-dimensional information of the determined scene 12 being different from each other, or the difference between the first and second set of three-dimensional information exceeding the pre-determined value.

The microprocessor 20 records coordinates of the moving object 14, and transmits a drive command to the driving module 40. The driving module 40 adjusts a lens angle and a focus of the image capture module 50 according to the drive command, thereby to make the lens of the image capture module 50 aim at the moving object 14 to capture images in focus of the moving object 14. In other exemplary embodiments, a buzzer (not shown) may be provided to give an alarm when the microprocessor 50 detects the moving object 14. The LIDAR system then transmits a next beam of laser light to scan the determined scene 12, to obtain a next set of three-dimensional information thereof. The microprocessor 20 compares the next set of three-dimensional information with the first set of three-dimensional information stored in the storage module 30, to determine whether there is a moving object in the determined scene 12.

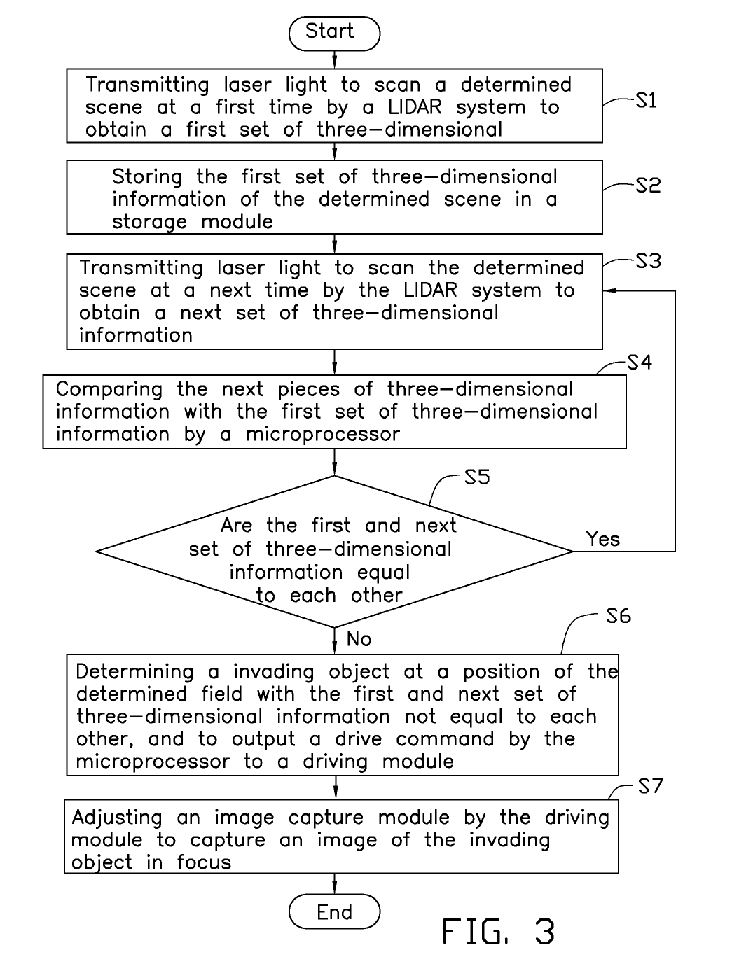

Referring to FIG. 3, an adjusting method for the camera device 100 is provided, which includes the following steps.

In step S1, the LIDAR system 10 transmits a first beam of laser light to scan the determined scene 12 at a first time, to obtain a first set of three-dimensional information of the determined scene 12.

In step S2, the first three-dimensional information of the determined scene 12 is transmitted to the microprocessor 20 and stored in the storage module 30, functioning as a set of standard information.

In step S3, the LIDAR system 10 continues to transmit a next beam of laser light to scan the determined scene at a next time, to obtain a second set of three-dimensional information of the determined scene 12.

In step S4, the second three-dimensional information of the determined scene 12 is transmitted to the microprocessor 20, and the microprocessor 20 compares the second set of three-dimensional information with the first set of three-dimensional information stored in the storage module 30.

In step S5, a determination is made whether the second and first sets of three-dimensional information of the determined scene 12 are equal to each other or not, or a difference between the first and second sets of three-dimensional information exceeds a pre-determined value or not; if the second and first sets of three-dimensional information of the determined scene 12 are equal to each other, or the difference between the first and second sets of three-dimensional information does not exceed the pre-determined value, the flow returns to step S3; if the first and second sets of three-dimensional information are not equal to each other, or the difference between the first and second sets of three-dimensional information exceeds the pre-determined value, the flow goes to step S6.

In step S6, the microprocessor 30 determines an invading object, e.g., moving object 14, at a position of the determined 12 with the second and first sets of three-dimensional information being different from each other, or the different between the second and first sets of three-dimensional information exceeding the pre-determined value, and transmits a drive command according to coordinates of the moving object 14 to the driving module 40.

In step S7, the driving module 40 adjusts a lens angle and a focus of the image capture module 50 according to the drive command, to make the lens of the image capture module aim at the moving object 14 to capture images of the moving object 14 in focus.

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A camera device, comprising:
an image capture module to capture an image of a determined scene;
a light detection and ranging (LIDAR) system to transmit laser light to scan the determined scene, thereby to obtain sets of three-dimensional information of the determined scene at different times;
a storage module for storing a first set of three-dimensional information of the determined scene obtained by the LIDAR system at a first time;
a microprocessor to compare a second set of three-dimensional information of the determined scene obtained by the LIDAR system at a second time, to determine an invading object, and record coordinates of the invading object thereby to transmit a drive command according the coordinates of the invading object; and
a driving module to receive the drive command from the microprocessor, and adjust the image capture module according to the drive command, to capture images of the invading object in focus.

2. The camera device of claim 1, wherein each of the first and second sets of the three-dimensional information of the determined scene includes three-dimensional coordinates of objects in the determined scene.

3. The camera device of claim 2, wherein the coordinates of the objects in the determined scene are obtained according to a speed of the laser light multiplied by half a time delay between transmission pulses and corresponding reflected pulses of the laser light from the LIDAR system to the object in the determined scene.

4. The camera device of claim 1, wherein the invading object is determined at a position of the determined scene with the second set of the three-dimensional information of the determined scene at the second time and the first set of the three-dimensional information of the determined scene at the first time not equal to each other, or a difference between the second set of the three-dimensional information at the second time and the first set of the three-dimensional information at the first time exceeding a pre-determined value.

5. An adjusting method for a camera device to adjust a lens angle and a focus of an image capture module, the method comprising:
scanning a determined scene by a light detection and ranging (LIDAR) system to obtain a first set of three-dimensional information of the determined scene at a first time;
storing the first set of three-dimensional information of the determined scene in a storage module;
scanning the determined scene by the LIDAR system to obtain a second set of three-dimensional information of the determined scene at a second time;
comparing the second set of three-dimensional information of the determined scene with the first set of three-dimensional information of the determined scene;
recording coordinates of a position in the determined scene with the second set of three-dimensional information at the second time not equal to the first set of three-dimensional information at the first time, or a difference between the first set of three-dimensional information at the first time and the second set of three-dimensional information at the second time exceeding a pre-determined value, to output a drive command by a microprocessor according the coordinates to a driving module; and
adjusting the image capture module by the driving module according to the drive command, to make the image capture module aim at the coordinates of the position in the determined scene.

6. The method of claim 5, wherein each of the first and second sets of the three-dimensional information of the determined scene includes three-dimensional coordinates of the object in the determined scene.

7. The method of claim 6, wherein the coordinates of the object in the determined scene are obtained according to a speed of the laser light multiplied by half a time delay between transmission pulses and corresponding reflected pulses of the laser light from the LIDAR system to the object in the determined scene.
